(19) United States
(12) Patent Application Publication
(10) Pub. No.: US 2007/0223225 A1
(43) Pub. Date: Sep. 27, 2007

(54) LED Lighting Unit Applied to a Fluorescent Lighting Fixture

(75) Inventors: Sugi Eiich, Osaka (JP); Hashizume Kenjiro, Osaka (JP)

Correspondence Address: WPAT, PC;INTELLECTUAL PROPERTY ATTORNEYS, 2030 MAIN STREET, SUITE 1300, IRVINE, CA, 92614, US

(73) Assignee: YASHIMA DENGYO CO., LTD., Osaka (JP)

(21) Appl. No.: 11/616,143

(22) Filed: Dec. 26, 2006

(30) Foreign Application Priority Data
Mar. 22, 2006 (JP) JP2006-078714

(51) Int. Cl. F21V 23/02

(52) U.S. Cl. 362/260

(57) ABSTRACT

A light emitting diode (LED) lighting unit applied to a fluorescent lighting fixture including a light emitting diode (LED) lighting unit mounted in an existing fluorescent lighting fixture; a source part being disposed in the LED lighting unit; polarity being switched by means of the source part installed in the LED lighting unit depending on the direction of the installation direction of the LED lighting unit; the LED lighting unit being capable of coping with changed polarity resulted from any direction of the installation; a first bridge rectifier and a second bridge rectifier installed in the LED lighting unit functioning to rectify the current supplied from a ballast of the fluorescent lighting fixture and to conduct a light emitting diode (LED) assembled unit connected in series and parallel.

### BACKGROUND OF THE INVENTION

(a) Field of the Invention

The present invention relates to a light emitting diode (LED) unit applied to a fluorescent lighting fixture, and more particularly, to one that replaces a fluorescent tube in comprehensively used fluorescent lighting fixtures and also involves energy and environmental technologies.

(b) Description of the Prior Art

A fluorescent tube has been widely used due to its advantages of providing longer service life and less power consumption than an incandescent light does. However, as the energy problem is getting worse today the leakage of mercury from wasted fluorescent light has become another source of pollution to the environment. Therefore, the idea of replacing the fluorescent tube with LED was taught in Japanese Utility Patent Gazette No. Showa 63-121461 (1988), and later in 1994 the feasibility of direct mounting of LED tube in the existing fluorescent lighting fixture was brought up in Japanese Utility Patent Gazette Heisei No. 06-54103. Should the latter be realized, it will do a great contribution to help solve energy and environmental problems. However, putting the feasibility in practice is frustrated by a number of difficulties to be described below.

### SUMMARY OF THE INVENTION

The primary purpose of the present invention is to provide a light emitting diode (LED) lighting unit to replace the fluorescent tube commonly used in the existing fluorescent lighting fixture.

To achieve the purpose, a source part provided in the LED lighting unit is to rectify the current supplied from a ballast of the fluorescent lighting fixture and to conduct a light emitting diode (LED) assembled unit. The source part comprises a first bridge rectifier, a second bridge rectifier, and a condenser. The LED assembled unit executes the allotment of connection in series and parallel for light emitting diodes to such that the light emitting diodes are capable of corresponding to the source voltage. While connecting the source in parallel to divide the source part into two units, a relay to switch between polarities is mounted to cope with the changed polarity caused by the mounting method used for the lighting fixture.

Accordingly, to control the temperature rise of the LED lighting unit, ventilation pores are disposed either on the upper or the lower part of a tube of the LED lighting unit.

Furthermore, an air blower for ventilation is provided in the LED lighting unit.

The method described above is capable of realizing the replacement of the existing fluorescent tube in the fluorescent lighting fixture with the LED lighting unit.

To realize the replacement with the LED lighting unit, it may be mounted in the existing fluorescent lighting fixture. To achieve this, the LED lighting unit must be capable of emitting light based on the existing foundation. Therefore, to take advantage of the source supplied by the fluorescent lighting fixture to execute LED lighting, it takes further to install a source part in the LED lighting unit to switch current direction. The demanded compact construction of the source part warrants improvement strategy to deal with the heat generated by the circuit becomes a topic for solutions.

Though the LED provides better light emitting results, the loss of light emission will generate heat that brings extremely negative impacts upon the service lives of the LED and other electronic parts. Therefore, the heating must be contained to its minimum.

A ballast or an electronic starter may be mounted in the existing fluorescent lighting fixture. Doing so will be at the expense of the symmetrical nature of the circuit. Therefore, the installation method of straight tube for the lighting fixture is used to change polarity. That is, four assembling methods comprised of the left, the right, turning to the right, and turning to the left are alternatively used in conjunction with the installation of the ballast or the electronic starter. LED lighting function will not be compromised by any of the four methods used.

A first bridge rectifier, a second bridge rectifier, and a condenser provided in the source part of the LED lighting unit are used to rectify the current supplied by the ballast of the existing fluorescent lighting fixture and to conduct the LED assembled unit. The LED assembled unit executes the allotment of the series and parallel connections for the light emitting diodes to cope with the source voltage, and then a resistance is installed in each group of LEDs connected in parallel.

In the course of having connected the first bridge rectifier, the second bridge rectifier and the condenser of the source part so to divide them into two units, the assembling method used by the LED lighting unit may be applied to cope with changed polarity and a relay to switch between polarities must be installed.

Ventilation pores communicating with the ambient air are disposed either on the upper or on the lower part of the tube of the LED lighting unit.

An air blower for ventilation is disposed inside the LED lighting unit.

The present invention provides the following advantages:
1. The loss consumed in the course of source conversion and the heating amount generated by the source circuit in the LED tube are controlled to its minimum since the present invention simply rectifies the current supplied by the ballast in the existing fluorescent lighting fixture for realizing direct lighting by the LEDs.
2. In the course of having connected the first bridge rectifier, the second bridge rectifier and the condenser of the source part so to divide them into two units, the method used by the lighting fixture is applied to cope with changed polarity and a relay to switch between polarities is provided to cope with the changed polarity resulted from the LED lighting unit installation method applied for the existing fluorescent lighting fixture.
3. The heat generated inside the tube is permitted to be dissipated to the ambient air while controlling the temperature rise inside the tube since air ventilation pores are disposed on the upper or the lower part of the tube of the LED lighting unit and the heat dissipation efficacy may be further upgraded if an additional air blower is installed inside the LED lighting unit.

### BRIEF DESCRIPTION OF THE DRAWINGS

FIG. 1 is a side view of the lighting fixture of a fluorescent light type replaced with an LED tube of the present invention,

FIG. 2 is a sectional view of the fluorescent light type replaced with the LED tube of the present invention,

FIG. 3 is a schematic view showing practical equipment of a loop inside the fluorescent light type replaced with the LED tube of the present invention,

FIG. 4 is a circuit diagram showing the lighting fixture of the fluorescent light type replaced with the LED tube of the present invention, and

FIG. 5 is a schematic view showing a front of a metallic cover holder of the present invention.

### DETAILED DESCRIPTION OF THE PREFERRED EMBODIMENTS

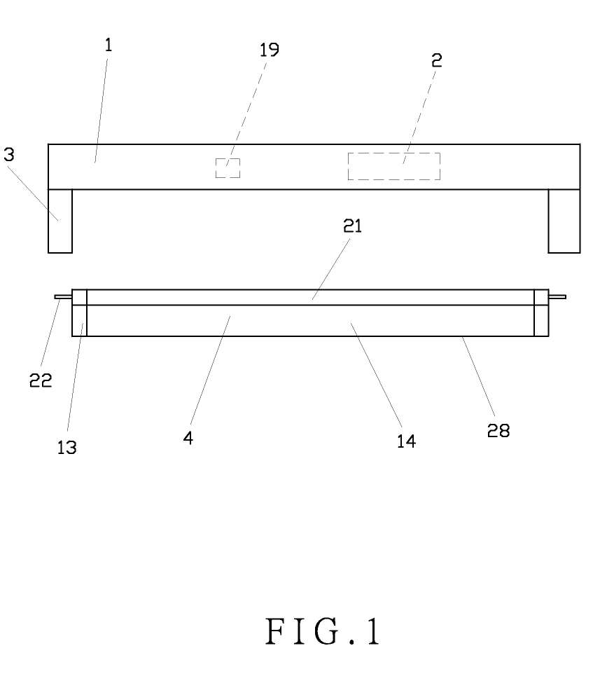

Referring to FIG. 1, the present invention is applied to an existing fluorescent lighting fixture (1) having a ballast (2), a fluorescent tube (19), and an installation part (3). A light emitting diode (LED) lighting unit (4) made in the same dimension as that of the existing fluorescent tube. A metallic cap (13) and a terminal (22) provided to the end of a tube (14) are mounting to the installation part (3) of the fluorescent lighting fixture (1).

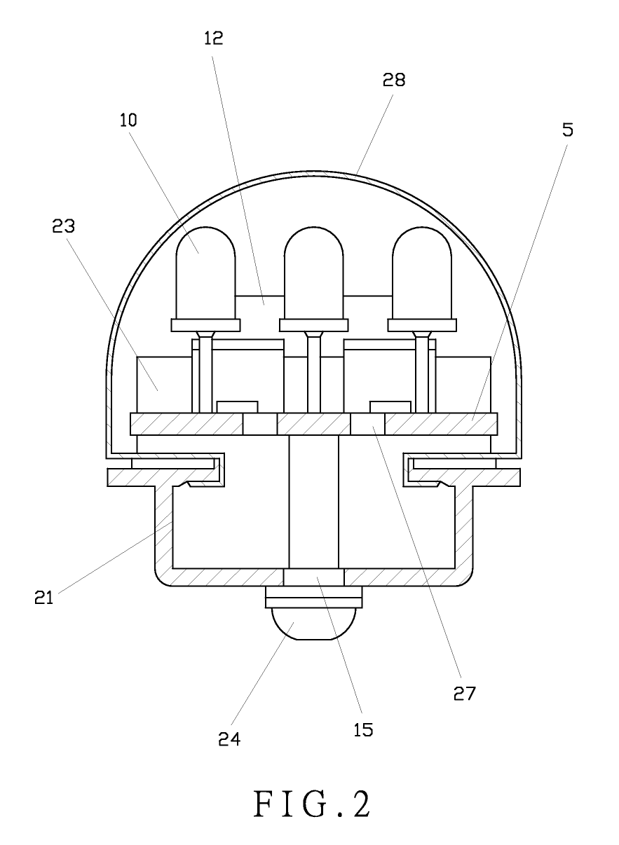

Now referring to FIG. 2 for a cross-sectional view of the LED lighting unit (4), the LED lighting unit (4) is provided with a track (21) made of metallic or molded plastic material as a holder and covered with a protection shade (28) made of a light permeable material. Both sides of the protection shade (28) are inserted into and tightly secured to the inner side at the upper part of the track (21). A plurality of light emitting diode (LED) substrates (5), a source substrate (6), and a metallic cover substrate (25) are disposed in the LED lighting unit (4) in parallel with the tube (14).

As illustrated in FIG. 2, the LED substrates (5) are disposed on and fixed to the track (21) with a mounting member (24) such as a bolt or a clamp. Meanwhile to prevent the substrates from being subject to stress, the pavement of a reinforcement material is desired. Pores (15) to execute air convection with external air are disposed in the track (21) to cope with temperature rise. Whereas pores (27) provided to the substrates and the pores (15) disposed in the track (21) may attract pests including mosquitoes to invade in the protection shade (28), linear connection among the pores is not preferred. In addition, crevices may be provided between the installation part (3) of the track (21) and the substrates in lieu of drilling pores in the substrates.

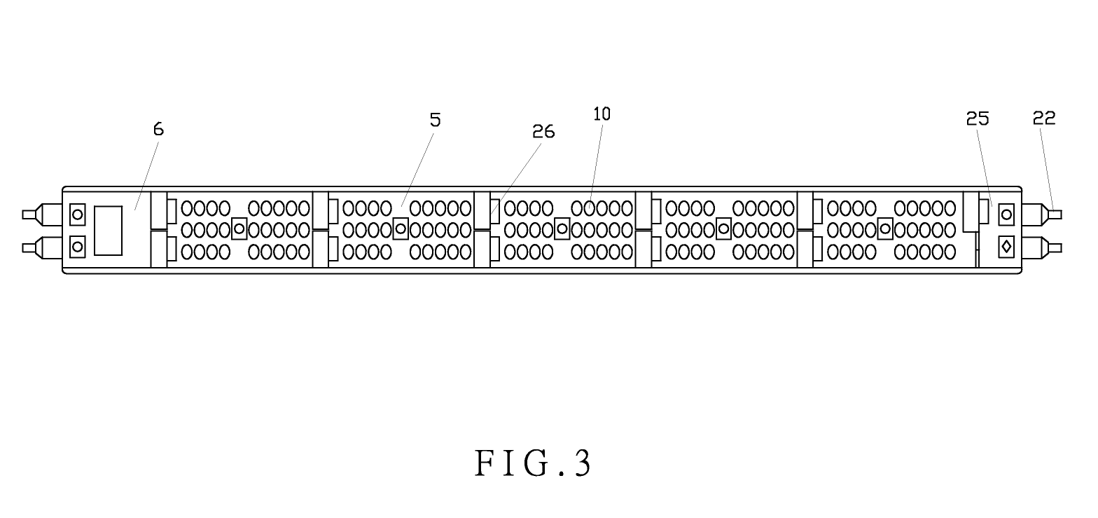

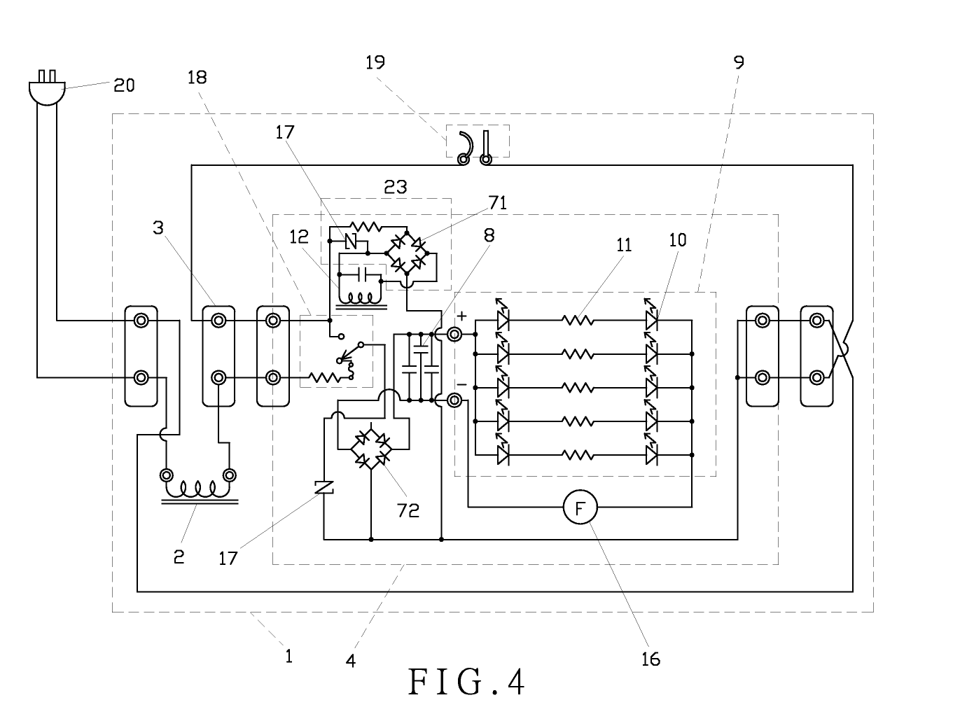

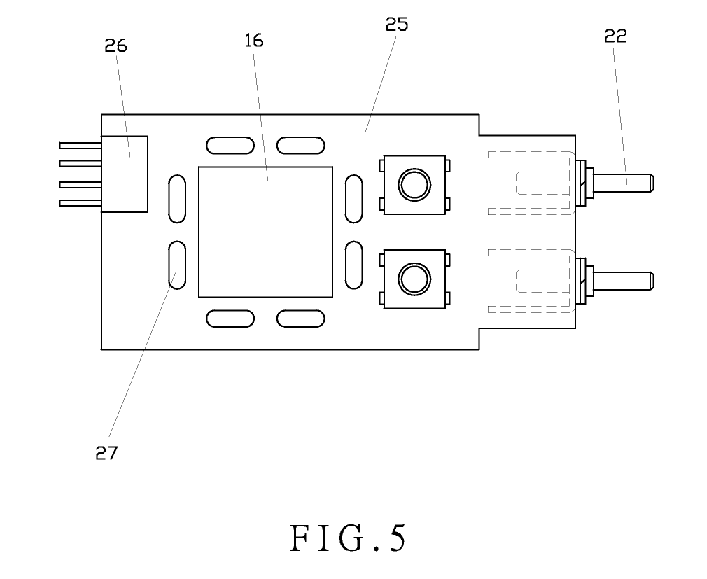

As illustrated in FIG. 3, the installation of the substrates inside the LED lighting unit (4) is composed of the source substrate (6) disposed to its left the terminal (22), five LED substrates (5) connected in series, and the metallic cover substrate (25) provided with the terminal (22) in sequence. The source substrate (6) contains a source part (23). Multiple light emitting diodes (10) are installed in series and parallel in each LED substrate (5) to cope with the source voltage. (In FIG. 3, there are 27 light emitting diodes in each LED substrate.) An air blower (16) is provided in the metallic cover substrate (25), as illustrated in FIG. 4. The pores (27) for air convection are disposed on the upper and lower parts of partial or all the substrates. The pores (27) are too small to be marked in FIG. 3. (Refer to FIGS. 2 and 5.) The reason for dividing the LED substrate (5) into five sheets that may be mutually connected by means of connectors (26) is for soonest achieving standardization thus to upgrade production output. A source circuit may be disposed on the inner side of the LED substrates (5).

According to the integral circuit diagram illustrated in FIG. 4, a commercial source may be supplied in the fluorescent lighting fixture (1) through a source plug (20). The ballast (2) and the fluorescent tube (19) may be disposed in the fluorescent lighting fixture (1); or alternatively, an electronic starter loop may be installed therein. A first bridge rectifier (71) is connected to the source part (23) to rectify alternating current inputted from the source part (23). A relay (12) is connected to the first bridge rectifier (71) and is conducted as excited by the current outputted from the first bridge rectifier (71). The relay (12) is further connected to a microtemp (18) to prevent the relay (12) from over-current. The microtemp (18) is connected to a second bridge rectifier (72) to test changed polarity of the current outputted by the relay (12).

A surge absorber (over-voltage absorber) (17) is disposed to each of the first and the second bridge rectifiers (71, 72) to prevent low voltage operation from being affected by voltage fluctuation and high frequency noise. A condenser (8) is connected in parallel with the output end of the second bridge rectifier (72) to lower the pulse ripples of the current outputted from the second bridge rectifier (72), and further to keep constant output voltage to approach the ideal direct current output voltage for delivering the current rectified by the second bridge rectifier (72) to a light emitting diode (LED) assembled unit (9). The LED assembled unit (9) functions to connect a total of 27 light emitting diodes (10) (There are only 10 light emitting diodes in FIG. 4.) and resistances (11) for constituting parallel connection in five rows so to directly cope with the voltage rectification as described above. The resistances (11) are to stabilize the current. The air blower (16) is connected in series with the LED assembled unit (9) to promote external convection to control the temperature rise inside the tube while circulating the air in the tube of the loop.

The first and the second bridge rectifiers (71, 72) connected in parallel are coupled to each other by means of the relay (12) to test changed polarity and to cope with four installation methods applied for the straight tube lighting fixture, that is to cope with changed polarity caused by any of the combined installation methods of the left, the right, turning to the right, and turning to the left. While installing the electronic starter circuit in the fluorescent lighting fixture (1) to achieve good circuit status, the coping efficacy can be further idealized with changed circuit parameters; or alternatively, the microtemp (18) may be installed to protect from over-current.

As illustrated in FIG. 5, serial connection allotment may be provided to the LED assembled unit (9) on the metallic cover substrate (25). The air blower (16) may be installed lengthwise along the tube to promote air convection with external air and control the temperature rise in the tube while circulating the air in the loop. A micro-fan or a dielectric chip fan may be provided in lieu of the air blower (16). The pores (27) may be provided to encourage the convection between the air over and below the metallic cover substrate (25).

Supposing that the power of the lighting made available by the present invention to reach triple-fold or higher, the present invention will help improve the glasshouse effects challenging the earth today. Furthermore, the present invention offers economic and convenient production since it may be forthwith installed in the existing fluorescent lighting fixture (1) without modifying it. While eliminating the disposal of the waste fluorescent tube and mercury leakage problem, the present invention also achieves the purpose of energy saving since the service life of LED is much longer than that of the fluorescent tube.

What is claimed is:

1. A light emitting diode (LED) lighting unit applied to a fluorescent lighting fixture comprising a tube, a light emitting diode (LED) assembled unit, and a source part, the light emitting diode (LED) assembled unit and the source part being disposed in the tube, the source part comprising a first bridge rectifier, a second bridge rectifier and a relay, the first bridge rectifier and the second bridge rectifier being installed in parallel, the relay being disposed between the first bridge rectifier and the second bridge rectifier to switch polarity, the first bridge rectifier and the second bridge rectifier rectifying the current and delivering the current to light emitting diodes of the light emitting diode (LED) assembled unit.

2. The light emitting diode (LED) lighting unit applied to a fluorescent lighting fixture as claimed in claim 1, wherein the tube is provided with pores.

3. The light emitting diode (LED) lighting unit applied to a fluorescent lighting fixture as claimed in claim 2, wherein an air blower is provided in the tube.

4. The light emitting diode (LED) lighting unit applied to a fluorescent lighting fixture as claimed in claim 1, wherein the tube is provided with a protection shade and a holder, the protection shade being made of light permeable material, the holder being formed with a track made of metallic or molded plastic material.

5. The light emitting diode (LED) lighting unit applied to a fluorescent lighting fixture as claimed in claim 4, wherein the track is provided with pores for air convection.

6. The light emitting diode (LED) lighting unit applied to a fluorescent lighting fixture as claimed in claim 4, wherein a source substrate, a metallic cover substrate and light emitting diode (LED) substrates are provided in the tube, the source substrate, the metallic cover substrate and the light emitting diode (LED) substrates being connected by means of connectors.

7. The light emitting diode (LED) lighting unit applied to a fluorescent lighting fixture as claimed in claim 6, wherein the source substrate, the metallic cover substrate and the light emitting diode (LED) substrates are provided with pores.

8. The light emitting diode (LED) lighting unit applied to a fluorescent lighting fixture as claimed in claim 1, the relay is connected with a microtemp, the microtemp being connected to the second bridge rectifier.
